(19) United States
(12) Patent Application Publication
(10) Pub. No.: US 2004/0088513 A1
(43) Pub. Date: May 6, 2004

(54) Controller for partition-level security and backup

(76) Inventors: David W. Biessener, Woodbury, MN (US); Kevin J. Tacheny, Woodbury, MN (US); Gaston R. Biessener, St. Paul, MN (US)

Correspondence Address: SHUMAKER & SIEFFERT, P. A., 8425 SEASONS PARKWAY, SUITE 105, ST. PAUL, MN, 55125, US

(21) Appl. No.: 10/284,700

(22) Filed: Oct. 30, 2002

(51) Int. Cl. G06F 12/00

(52) U.S. Cl. 711/173

(57) ABSTRACT

A computing system includes a processor having an operating system executing thereon, a storage system having one or more storage media, and a controller coupled between the processor and the storage system. The controller maintains partition data defining one or more partitions for the storage media in response to commands received from the operating system, and controls access to the storage media in accordance with the partition data. The controller selects a subset of the partitions as active partitions, and communicates to the operating system a portion of the partition data that defines the active partitions. The controller may, for example, select the subset based on a current authenticated user. The controller intercepts storage access requests from the processor, and rejects storage accesses requests that are not directed to the active partitions.

### TECHNICAL FIELD

This invention relates generally to computing environments and, more particularly, to data storage within computing environments.

### BACKGROUND

Typical computing systems include one or more computing devices, such as desktop computers, laptop computers, hand-held computers, database servers, file servers, web servers, supercomputers, and the like. Each of these devices typically includes one or more host processors, and one or more storage devices having storage media for storing data and executable software modules.

In order to facilitate the exchange of data between the storage devices and the host processor, many computing systems implement a complex, layered approach to managing the stored data. The physical storage media and the storage devices that control access to the media reside at the bottom layers. Each storage medium may also be referred to as a physical drive.

A partition is a logical storage region associated with the physical storage media present in the system. For example, a partition can be created for each physical storage medium in the system. As another example, a single, large partition can be created from multiple physical storage media. Alternatively, several smaller partitions can be created from a single physical storage medium. In this configuration, the partitions can be viewed as logical subdivisions of the storage medium.

An operating system executing within the computing system is typically used to create and manage the partitions. In particular, the operating system generates a partition table that stores data defining the individual partitions. The partition table may store, for example, information required to access the partitions. The operating system designates one of the partitions as a primary boot partition upon which instructions for a boot procedure are stored in a designated location, e.g., a first addressable logical block address. The operating system stores the partition table in a pre-defined location.

In some computing environments, such as those environments based on the Windows operating system from Microsoft, the operating system maintains a master boot record (MBR) within the first addressable physical storage unit that contains a small bootstrap program as well as the partition table. To change the partitions within a system, one or more of the storage media often must be physically reformatted, and a new partition table written.

In addition, the operation system layers a logical structure on top of the partitions for organizing the stored data, i.e., a file system. The file system typically includes hierarchical data structures for locating individual data files within the partitions. For example, the operating system may allow the creation of one or more logical volumes, file directories, and other structures within the file system. This process of creating the logical structure is often referred to as “high-level” formatting of the partitions. This is distinct from the “low-level” formatting of the underlying storage media at which time the partition table is created.

### SUMMARY

In general, the invention is directed to techniques for providing hardware-based, partition-level security in a computing environment. In particular, a controller is described that resides between a host processor and one or more underlying physical storage devices having one or more physical storage media. The controller provides hardware-level security and control over the partitions defined for the physical storage mediums. For example, the controller can prevent unauthorized access to the partitions. Further, the controller may provide hardware-level security on a directory basis, or even a file basis. In addition, the controller provides for the dynamic update and modification of the partitions.

The controller allows an operating system executing on the processor to create partitions in a format required by the operating system. For example, the operating system may perform a low-level format of the storage media, resulting in one or more partition tables. The controller intercepts storage access requests from the processor, and enforces controlled access to the respective partitions in accordance with the partition tables.

The controller also provides hardware-level backup and restoration of individual partitions, i.e., on a partition-by-partition basis, in a manner that appears nearly instantaneous to the user. The controller may, for example, allocate primary virtual storage and secondary virtual storage within one or more of the partitions for use in dynamically saving and restoring data written to the respective partitions. In particular, the controller uses the primary virtual storage of a given partition to store an initial state of data written by a computing device prior to a point in time, referred to herein as time T₀. In other words, the primary virtual storage stores a complete image of the data at time T₀. The controller uses the secondary virtual storage to store all data written by the computing device subsequent to time T₀. Consequently, the controller responds to read requests received from the computing device by selectively reading data from the secondary virtual storage and the primary virtual storage, depending on whether data stored by the primary virtual storage has been rendered obsolete by data stored by the secondary virtual storage.

The controller provides the ability to quickly create a new complete image of the data on any partition by dynamically reallocating the primary virtual storage and the secondary virtual storage associated with the partition. In particular, the controller maintains a map that defines the allocation of the primary and secondary virtual storage of the partition. By adjusting the map, the controller can quickly reallocate the primary virtual storage of the partition to include the data written to the secondary virtual storage, thereby establishing a new time T₀ for the primary virtual storage of the partition. In this manner, the controller can backup data in a manner that appears almost instantaneous to the user.

In one embodiment, a computing system comprises a processor having an operating system executing thereon, a storage system having one or more storage media, and a controller coupled between the processor and the storage system. The controller maintains partition data defining one or more partitions for the storage media in response to commands received from the operating system, and controls access to the storage media in accordance with the partition data.

In another embodiment, a method comprises maintaining with a controller partition data that defines one or more partitions for a storage medium in response to commands received from a processor executing on processor coupled to the controller, and processing the partition data with the controller to select a subset of the partitions as active partitions. The method further comprises identifying the active partitions to the processor

In another embodiment, an apparatus comprises a computer-readable medium to store partition data that defines partitions for one or more storage media of a storage system, and a control unit to maintain the partition data in response to commands from an operating system executing on a processor of a host computer. The apparatus further comprises a first interface to couple the control unit to the processor via a bus. The control unit controls access to the storage media of the storage system in accordance with the partition data.

The invention provides a number of advantages. As one example, a controller in accordance with the invention can provide hardware-level security to prevent unauthorized access to the partitions by a host processor or any software application executing on the processor, such as viruses. In particular, the controller may selectively present individual or groups of the defined partitions to the operating system, and may prevent or provide limited access to the other partitions. Consequently, the controller may provide authorized users secure access to respective partitions or groups of partitions, and the operating system may overlay a file system on the respective partitions in a conventional manner.

Nevertheless, the operating system may directly format and otherwise manage the active partitions, e.g., in response to a format command and other commands issued by a user. Further, the operating system may create a file system on top of the partitions in conventional fashion. In other words, although the controller provides hardware-level protection for the partitions, the operating system may interact with the partitioned storage media in a conventional manner. Consequently, the operating system, and any software applications and drivers executing on the processor, need not be modified to work with the partitions.

Another advantage is that any of the partitions may be presented to the processor as read-only partitions. Furthermore, the controller may present the primary virtual storage or the secondary virtual storage of a partition, or any combination thereof, as a separate partition in writable or read-only form. This may be useful for selectively restoring data from secondary virtual storage to the primary virtual storage in a secure fashion.

In addition, the invention provides the ability to quickly backup and restore data for any partition by dynamically reallocating virtual storage, such as by adjusting a respective virtual storage map associated with the partition. In this manner, the controller can backup and restore data in a manner that appears almost instantaneous to the user.

Consequently, the controller may be used to provide a secure means for saving and restoring data that is not susceptible to malicious network users, viruses, or other such devices. In addition, the controller may provide a dedicated hardware interface for saving and restoring data that is physically separate from the computing device and the software executing thereon. A user, such as a system administrator, may save and restore the data by actuating a hardware switch or interacting with the controller via a secure dedicated connection or wireless link.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example system in which a controller provides hardware-level data storage security on a partition-by-partition basis.

FIG. 2 illustrates an example data structure for a partition table maintained by the controller.

FIG. 3 illustrates an example partition entry for the partition table of FIG. 2.

FIG. 4 illustrates example data maintained with the partition entry for use by the controller in providing partition-level backup and restoration.

FIG. 5 illustrates an example embodiment of a partition table maintained by the controller.

FIG. 6 is a block diagram illustrating exemplary configuration of a partition that the controller has configured for restoration and backup.

FIG. 7 illustrates an example embodiment of a controller implemented as a single printed circuit board that may be embedded within a host computing device.

FIG. 8A illustrates an example embodiment of an input/output (I/O) device for issuing save and restore commands to the controller.

FIG. 8B illustrates another example embodiment of an input/output (I/O) device for issuing save and restore commands to the controller.

FIG. 9 is a block diagram illustrating the relationship between a file system, partitions, and physical storage drives.

FIG. 10 is a flowchart illustrating a high-level overview of the hardware-level security and management features provided by the controller on a partition-by-partition basis.

FIG. 11 is a block diagram illustrating in further detail an example partition configured for backup and restoration.

FIG. 12 illustrates an example mapping of a primary virtual storage and a secondary virtual storage to a partition at a time T₀.

FIG. 13 illustrates the same virtual storage at time a new time T₀ after the controller has performed a save operation, thereby dynamically reallocating the primary and secondary virtual storage.

FIG. 14 is a flowchart illustrating a high-level overview of the functions performed by the controller to backup a partition in a manner that appears substantially instant to a user.

FIG. 15 is a flowchart further illustrating an exemplary process of dynamically allocating the virtual storage of a partition.

FIGS. 16A-16E illustrate in further detail the process of dynamically reallocating virtual storage of a partition to save data in a manner that appears instantaneous to a user.

FIG. 17 is a block diagram illustrating another embodiment of a data structure maintained by the controller to allocate the virtual storage and to record locations of data written to the secondary virtual storage.

FIG. 18 is a flowchart illustrating the controller backing up data by dynamically reallocating virtual storage using the data structure of FIG. 17.

FIG. 19 is a block diagram illustrating another embodiment of a data structure maintained by the controller to allocate the virtual storage and to record locations of data written to the secondary virtual storage.

FIG. 20 is a flowchart illustrating the controller backing up data by dynamically reallocating virtual storage using the data structure of FIG. 19.

FIG. 21 is a block diagram illustrating another embodiment of a data structure maintained by the controller to allocate the virtual storage.

### DETAILED DESCRIPTION

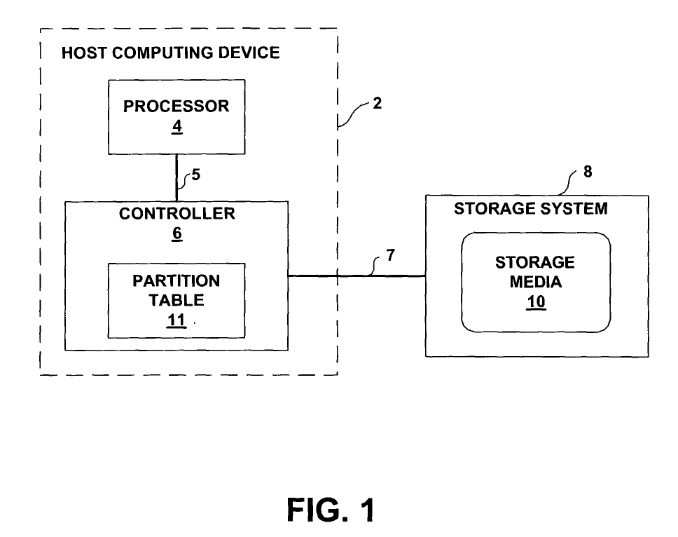

FIG. 1 is a block diagram illustrating an example system 1 in which a host computing device 2 includes a controller 6 that provides hardware-level data security for storage system 8 on a partition-by-partition basis. As illustrated in FIG. 1, host computing device 2 includes a processor 4 that is coupled to a storage system 8 via controller 6.

Storage system 8 provides a system for storing data and executable software modules for use by processor 4. Storage system 8 may comprise, for example, one or more underlying physical storage devices having one or more physical storage media 10. Storage media 10 may include, for example, one or more conventional magnetic disk drives, magneto optical storage devices, CD-ROMS, tape drives, removable storage media, optical storage media, volatile storage memory, EEPROM and the like. Storage system 8 may reside external to host computing device 2, as illustrated in FIG. 1, or may reside internal to the host computing device.

Processor 4 may be any type of programmable processor. Processor 4 may comprise a general-purpose processor within, for example, a desktop computer, a laptop computer or a network server, such as a file server, a web server or a database server. In addition, processor 4 may be an embedded processor operating within a networked or stand-alone appliance.

Controller 6 receives storage access requests, such as conventional read and write requests, from processor 4 via interconnect 5. In response, controller 6 manages storage system 8 by issuing commands to the storage system via interconnect 7. In this manner, controller 6 can be viewed as a hardware gateway disposed between processor 4 and storage system 8. Interconnects 13, 15 may conform to, for example, the Small Computer System Interface (SCSI), Internet Small Computer System Interface (iSCSI), a Fiber Channel interface, Integrated Drive Electronics/AT Attachment (IDE/ATA) interface, Serial ATA (SATA), or the like.

As described, controller 6 provides hardware-level security and control over the partitions defined for the physical storage media 10. In particular, controller 6 maintains a partition table 11 that defines one or more partitions for the physical storage media 10 of storage system 8.

Controller 6 presents the partitions defined by partition table 11 to an operating system executing on processor 4, e.g., for use in accordance with a file system. In other words, the operating system may utilize the partitions in a manner consistent with usage of conventional partitions across physical storage drives. In this manner, controller 6 can be viewed as being compatible with existing computing devices, yet may provide hardware-level security and control over partition table 11 and the defined partitions.

Specifically, controller 6 may reject, intercept, modify or otherwise process storage access requests from processor 4 in view of hardware-based partition table 11. Controller 6 may prevent unauthorized access to one or more of the partitions based on parameters set within partition table 10, and may prevent corruption of partition table 11 itself.

Controller 6 selectively presents individual or groups of the partitions to processor 4 depending on a current configuration of host computer 2. For example, for a current configuration, any number of the partitions may be “offline” and inaccessible to processor 4, while other partitions may be “online.”

In particular, a current user may be required to enter a password or provide other security information to log into host computing device 2. Based on the security information, controller 6 reads partition table 11 and presents partition information to the operating system for only those partitions accessible via the user. In other words, controller 6 may communicate only a portion of partition table 11 to the operating system, and may represent the inaccessible partitions simply as unavailable storage space.

Controller 6 presents the active partitions, i.e., the “online” partitions, to the operating system for use with a conventional file system. Controller 6 rejects all storage access commands, including all read and write requests, directed to the secure partition. In this manner, controller 6 restricts access to the respective partition, and provides hardware-level security on a partition-by-partition basis. As such, controller 6 protects the offline partitions from inadvertent modification by a user, corruption via malicious software, such as a virus, and the like.

Nevertheless, the operating system may reformat or otherwise reallocate one or more of the online partitions, e.g., by issuing a conventional format command. In response, controller 6 may regenerate all or a portion of partition table 11. Consequently, controller 6 may provide for the dynamic update and modification of the partitions, without requiring the reformatting of storage media 8. This feature may result in substantial time savings.

In addition, controller 6 may further manage partition table 11 and storage system 8 to provide a secure backup for data written by processor 4. Moreover, controller 6 provides mechanisms to backup and restore data in a manner that appears instantaneous to a user. In particular, within any number of the partitions, controller 6 may allocate and maintain a primary virtual storage and a secondary virtual storage, collectively referred to as virtual storage. Controller 6 may dynamically allocate and reallocate virtual storage within any of the partitions for selective backup and restoration of the respective partition.

Controller 6 stores partition table 11 in non-volatile storage for persistence. Controller 6 may, for example, store partition table 11 on one or more of storage media 10. Alternatively, or in addition, controller 6 may store partition table 11 within an internal non- volatile memory, such as a FLASH memory or battery-backed static random access memory (SRAM).

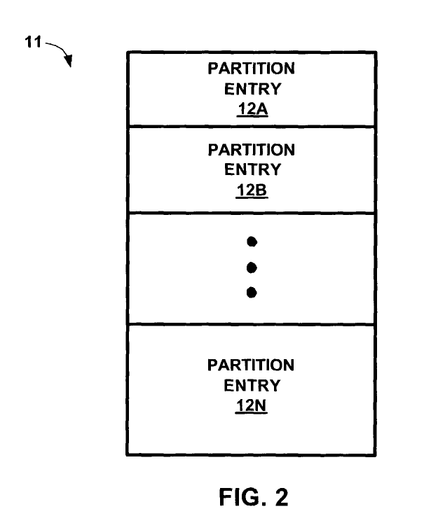

FIG. 2 illustrates an example data structure maintained by controller 6 for partition table 11. More specifically, in the example, partition table 11 includes a plurality of partition entries 12A-12N. A conventional partition table conforming to the Microsoft Disk Operating System (MSDOS), includes four partition entries. Consequently, in one embodiment, partition table 11 may include entries for compatibility with computing devices executing the Windows operating system from Microsoft Corporation.

Each partition entry 12 may include data to describe a respective partition for storage media 10. In addition, as described in more detail below, each entry may include additional data for use by controller 6 to provide hardware-level control, and instantaneous backup and restoration, of individual partitions.

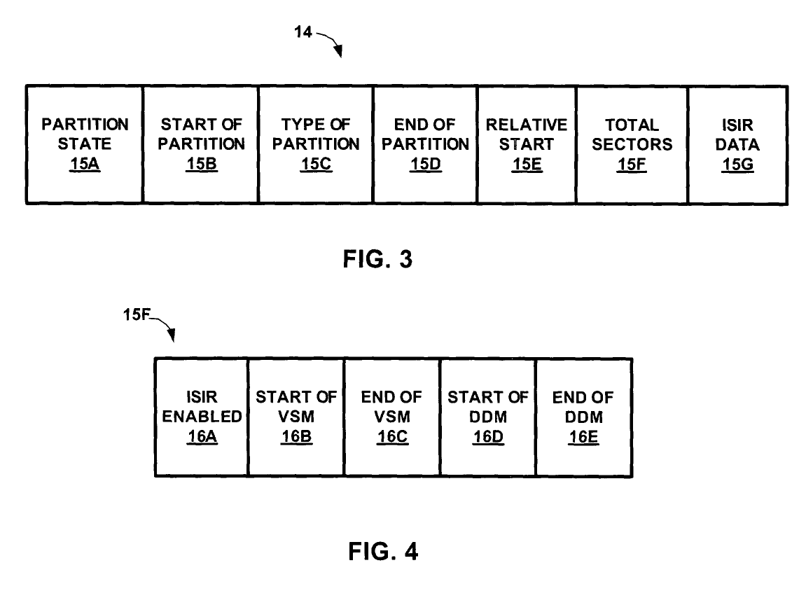

FIG. 3 illustrates an example partition entry 12 of FIG. 2 in further detail. In particular, partition entry 12 includes a number of data fields 15A-15F. The first data field, PARTITION STATE 15A, defines a number “states” for the respective partition. PARTITION STATE 15A may define a number of states not available via a conventional partition table, as illustrated in the following table:

TABLE 1

| PARTITION STATE | STATE |
|---|---|
| 00h | NOT BOOTABLE |
| 01h | READ ONLY |
| 02h | SECURE |
| 80h | BOOT PARTITION |
| 81h | BOOT/READ ONLY |

In particular, the value of 00 h indicates that the respective partition is a “non-primary” partition, i.e., a non-bootable partition. In other words, the respective partition does not contain a bootstrap for starting processor 4. In contrast, a value in which the high-order bit is set, e.g., 80 h or 81 h indicates that the partition is bootable.

A value of 01 h indicates that the partition is in a read-only state. For this state, controller 6 processes the storage access commands from processor 4 to reject any write commands directed to the partition. A value of 02 h indicates the respective partition is secure, and not currently accessible. For example, the particular user may be required to enter a password or provide other security information to access the secure partition. In this case, controller 6 rejects all storage access commands, including all read and write requests, directed to the secure partition. In this manner, controller 6 restricts access to the respective partition, and provides hardware-level security on a partition-by-partition basis.

Referring again to FIG. 3, the second data field, START OF PARTITION 15B, stores starting information for the respective partition. For example, start of partition 15B may store a starting head, cylinder and sector of one of storage media 10 for the respective partition. Alternatively, partition table 16 may maintain a starting logical block address (LBA) for each partition, e.g., when storage system 10 handles the mapping of LBAs to the physical regions of the storage device.

The third data field, TYPE OF PARTITION 15C, stores data defining a type for the respective partition. For MS-DOS compatible partitions, start of partition 15C may indicate whether the partition in a standard partition, indicated by the identifier “BIGDOS,” or an extended partition, indicated by “EXTENDED.”

END OF PARTITION 15D stores ending information for the respective partition. For example, END OF PARTITION 15B may store an ending head, cylinder and sector of one of storage media 10 for the respective partition.

The fifth data field, SECTORS TO START 15E, indicates a relative offset in sectors to the respective partition. For MS-DOS compatible systems, SECTORS TO START 15E indicates the number of sectors between a master boot record storing partition table 11 and the starting sector of the respective partition. TOTAL SECTORS 15F indicates a total number of sectors for the partition.

In addition, partition entry 14 includes data for use by controller 6 in providing partition-level backup and restoration, i.e., INSTANT SAVE-INSTANT RESTORE (IS-IR) DATA 15G.

FIG. 4 illustrates example data stored within IS-IR data 15G. In the illustrated example, IS-IR DATA 15G includes a first bit, IS-IR ENABLED 16A, that indicates whether the respective partition is configured for partition-level backup and restoration.

When enabled, controller 6 stores data within START OF VSM 16B and END OF VSM 16C to identify a location for a virtual storage map (VSM) for the respective partition. Furthermore, controller 6 stores data within START OF DDM 16D and END OF DDM 16E to identify a location for a delta data map (DDM) for the respective partition.

As described in more detail below, for each IS-IR enabled partitions, controller 6 maintains a VSM that defines an allocation of primary and secondary virtual storage within the respective partition. Controller 6 maintains the DDM to record the locations of data written to secondary virtual storage 27 in response to storage access requests from processor 4. To quickly and efficiently backup and restore data, controller 6 dynamically allocates and reallocates the primary and secondary virtual storage of the respective partition. Controller 6 may maintain the VSM and the DDM for each IS-IR enabled partition within an internal embedded memory, within the respective partition, or both.

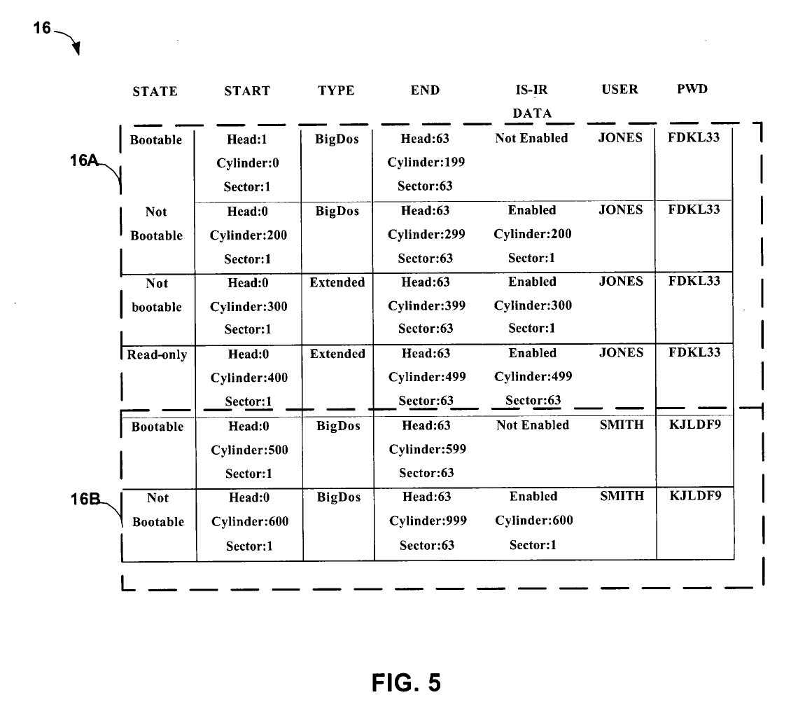

FIG. 5 illustrates an example embodiment for a partition table 11. In the illustrated example, partition table 11 includes six partition entries, represented as rows within the partition table. Partition table 11 stores a first group of partitions 16A associated with a first user, and a second group 16B associated with a second user.

Specifically, the first four partition entries of partition table 11 define active partitions for a user JONES. Upon receiving security information of FDKL33 and a user identifier of JONES, controller 6 presents the first group 16A to the operating system as if the group constituted a complete partition table. Controller 6 does not include the fifth and sixth partition entry, i.e., group 16B. Furthermore, controller 6 may exclude specific data utilized by the controller, e.g., the IS-IR data used for backup and restoration.

The first group of partitions, i.e., group 16A, includes a bootable partition, two non-bootable partitions, and a read-only partition. When utilizing the first group, controller 6 provides partition-level security by rejecting any write-access request to the read-only partition, and rejecting all access requests to storage areas outside of the first four partitions.

Similarly, upon receiving security information of KJLDF9 and a user identifier of SMITH, controller 6 presents the second group 16B to the operating system as a complete partition table. Consequently, in this mode of operation, rejects all access requests from processor 4 that specify storage areas outside of the last two partitions.

As described, partition table 11 defines six partitions even though the operating system may support fewer partitions, e.g. four partitions. In general form, partition table 11 may define N partitions, and the operating system may support M partitions, where N may be less than, equal, or even greater than M. As one example, M may equal 4.

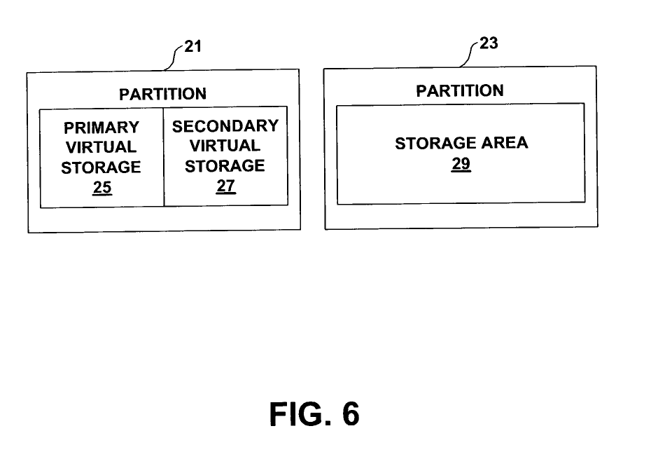

FIG. 6 is a block diagram illustrating exemplary configuration of a partition 21 that has been configured for restoration and backup, i.e., is IS-IR enabled. In this example configuration, controller 6 has allocated within partition 21 a primary virtual storage 25 and a secondary virtual storage 27 for use in providing restoration and backup. In other words, controller has defined virtual storage 25, 27 within the physical storage area associated with partition 21 via partition table 11.

Controller 6 uses primary virtual storage 25 to store an initial state of data written by processor 4 to partition 21 prior to a point in time, referred to herein as time T₀. In other words, primary virtual storage 25 stores a complete image of the data at time T₀. Controller 6 uses secondary virtual storage 27 to store all data written by processor 4 subsequent to time T₀. Consequently, controller 6 responds to read requests for partition 21 received from processor 4 by selectively reading data from secondary virtual storage 27 and primary virtual storage 25, depending on whether data stored by primary virtual storage 25 has been rendered obsolete by data stored by secondary virtual storage 27. In order to respond to a read request, controller 6 determines whether the requested data has been written to primary virtual storage 25, or has been superceded by data written to secondary virtual storage 27. Controller 6 then selectively reads data from secondary virtual storage 27 and primary virtual storage 25 in response to the read request.

In order to quickly and efficiently backup and restore data, controller 6 dynamically allocates and reallocates virtual storage 25, 27 of partition 21. In particular, controller 6 maintains a virtual storage map (VSM) that defines the allocation of the primary and secondary virtual storage 25, 27 within partition 21. In response to a save (backup) command, controller 6 updates the VSM, dynamically reallocating primary virtual storage 25 to include the data written to secondary virtual storage 27. Consequently, controller 6 dynamically reallocates secondary virtual storage 27 to exclude the data.

In this manner, controller 6 quickly establishes a new time T₀ in which primary virtual storage 25 stores all of the data received prior to time T₀. Controller 6 can save (backup) the data in the manner that appears instantaneous to a user. Specifically, by dynamically allocating and reallocating virtual storage 25, 27 of partition 21 upon receiving the save command, controller 6 avoids copying any of the actual data in order to perform a backup.

In addition to the ability to save data in a manner that appears instantaneous to a user, controller 6 can also revert back to the previously saved state in similar fashion. Specifically, upon receiving a restore command, controller 6 can simply disregard the data written to secondary virtual storage 27, thereby reverting to the data stored by primary virtual storage 25. In this manner, controller 6 can quickly revert to using data stored prior to a time T₀.

Controller 6 may present partitions to processor 4 as read-only partitions, e.g., as controlled by PARTITION STATE 15A of partition table 11. Furthermore, controller 6 may present primary virtual storage 25 or secondary virtual storage 27 of a given partition, or any combination thereof, as a separate partition in writable or read-only form. This may be useful for selectively restoring data from secondary virtual storage to the primary virtual storage in a secure fashion.

Furthermore, controller 6 may provide additional security on a partition-by-partition basis by filtering any unauthorized commands received from processor 4. Controller 6 may, for example, filter unpublished, vendor-specific commands received from processor 4. In addition, controller 6 may filter published but unwanted commands, or may translate the unwanted command to an acceptable command. Controller 6 may selectively filter the commands based on configuration information defined by a user, such as a system administrator, on a partition-by-partition basis. In this manner, controller 6 may provide a bus-level filter for access commands issued to storage system 8.

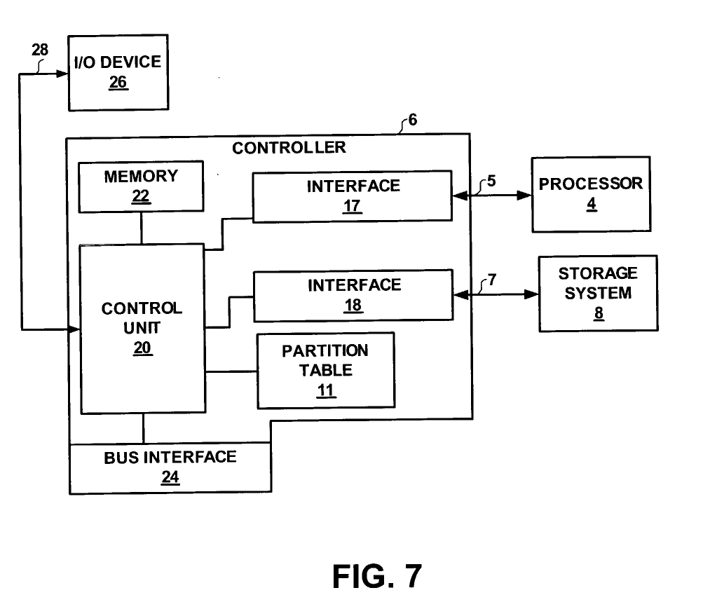

FIG. 7 illustrates an example controller 6 implemented as a single printed circuit board that may be embedded within a host computing device. In this embodiment, controller 6 may include partition table 1 1, a first interface 17, a second interface 18, control unit 20, embedded memory 22 and bus interface 24. First interface 17 and second interface 18 provide mechanisms for coupling controller 6 between processor 4 and storage system 8, respectively. Specifically, control unit 20 receives storage access commands from processor 4 via interconnect 5 and first interface 17. In addition, control unit 20 manages and accesses storage system 8 via interconnect 7 and second interface 18. Although illustrated as implemented on a printed circuit board, controller 6 may be embedded within a motherboard along with processor 4, within storage system 8, or within other components of system 2 disposed between processor 4 and storage system 8.

As described, control unit 20 maintains partition table 11 to define one or more partitions for the physical storage media 10 (FIG. 1) of storage system 8. Controller 6 provides hardware-level security and control over the partitions defined by partition table 10.

Although illustrated as a single partition table 11, controller 6 may maintain a plurality of partition tables, each for different authorized users. In this manner, certain partitions may be active for some users, but secure, i.e., inaccessible to others. Alternatively, controller 6 may maintain a single partition table 11 that stores profiles of different users, and sets the status of each partition based on the stored user profiles. Upon reading a respective partition table 11 for the user, controller 6 analyzes the partition table 11 to determine the active partitions. Controller 6 presents the active partitions to the operating system for use with a conventional file system.

In addition, for each partition configured for backup and restoration, control unit 20 maintains a virtual storage map (VSM) and a delta data map (DDM). Control unit 20 may store the maps, if any, and other information within internal memory 22. Alternatively, or in addition, control unit 20 may store the maps and other information within storage system 8 for persistency, or within both memory 22 and storage system 8, e.g., for purposes of redundancy.

Control unit 20 may also receive data backup (SAVE) and restoration (RESTORE) commands directly from I/O device 26. In particular, I/O device 26 may be a dedicated device by which a user issues commands to controller 6, thereby bypassing processor 4. In this manner, I/O device 26 and controller 6 provide a secure means for saving and restoring data within storage system 8. Consequently, controller 6 and storage system 8 are not subject to attacks via network hackers, viruses or other malicious software.

I/O device 26 may comprise a keyboard, pointing device or other conventional input mechanisms. In one embodiment, I/O device 26 comprises a panel mounted to host computing device 2. Alternatively, I/O device 26 may comprise a dedicated communication link or wireless device by which a user, such as a network administrator, may save and restore data within storage system 8. In this embodiment, signals 28 may represent wireless communications received by controller 6 from I/O device 26.

Alternatively, controller 6 may receive commands, such as save and restore commands, from bus interface 24, interface 17, or combinations thereof. Bus interface 24 provides a mechanism with which controller 6 may electrically coupled to a data communications bus for additional communications with processor 4 within host computing device 2. Bus interface 24 may, for example, comprise a PCI bus. Alternatively, bus interface 24 may simply provide power and ground signals for use by controller 6.

Although illustrated for exemplary purposes as a single printed circuit board, controller 6 may be readily incorporated within a bus controller, such as a bus controller residing on a motherboard within host computer 2. In this embodiment, interfaces 17, 18 may be combined into a single interface. In other words, controller 6 manages bus communications between processor 4 and storage system 8. This embodiment may offer one or more advantages, such as reduced communication latency, reduced redundancy of bus control logic, improved communication efficiency, and the like. Similarly, controller 6 may be incorporated within a controller on storage system 8.

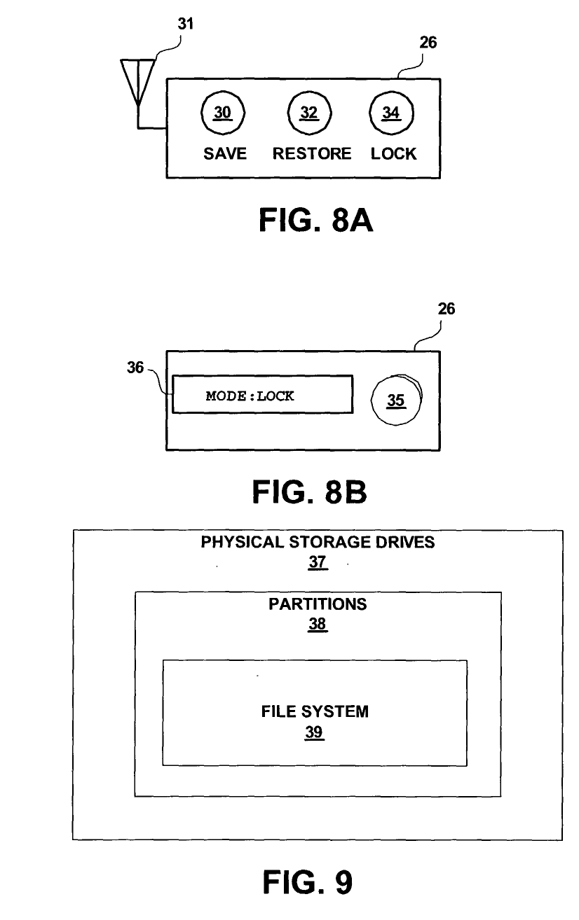

FIG. 8A illustrates an example embodiment of an I/O device 26 comprising an I/O panel mounted to host computing device 2. In the illustrated embodiment, I/O device 26 includes a save button 30, a restore button 32, and a lock button 34. Actuation of save button 30 causes I/O device 26 to issue a save command to control unit 20 of controller 6. In response, controller 6 saves one or more of partitions that are configured for data backup and restoration, and that are currently accessible, i.e., not marked “secure” via partition table 11.

Similarly, actuation of restore button 32 causes I/O device 26 to issue a restore command to controller 6. In response, controller 6 restores one or more of the partitions that are configured for data backup and restoration. Lock button 34 may be used to prevent controller 6 from performing an unauthorized or accidental save or restore operation. Specifially, actuation of lock 34 may prevent controller 6 from responding to a save command or restore command until specifically unlocked.

I/O device 26 may include other features such as a display of the last date and time at which a save was performed. In addition, I/O device 26 may include mechanisms by which a user enters an authorization code or provides other secure information such as a digital key to be used for authenticating the user.

I/O device 26 need not be directly coupled to the host computing device. For a wireless device, I/O device 26 may include antenna 31 to communicate with controller 6 via radio frequency or other appropriate mechanisms. I/O device 26 and controller 6 may be configured to communicate, for example, via cellular or infrared communications or may be enabled as BLUETOOTH, 802.11(a), 802.11(b), 802.11(g) or other wireless applications. Alternatively, I/O device may comprise a removable panel that engages controller 6 via an I/O port of other communication means.

FIG. 8B illustrates another example embodiment in which I/O device 26 includes a display area 36 and an input dial 35. Controller 6 displays status information and a current operating mode within display area 36. By interacting with dial 35, a user may perform a number of operations including a restore or a save operation. In addition, the user may place controller 6 in a mode for receiving field upgrades to internal operating software. In one embodiment, controller 6 initializes to a safe mode, i.e., LOCKED, upon power-up, thereby requiring user interaction with dial 35 prior to processing SAVE or RESTORE commands for the virtual drives. In this manner, controller 6 provides a security mechanism in the event that controller 6 accepts SAVE and RESTORE commands from software executing on processor 4 or a remote computing device.

FIG. 9 is a block diagram illustrating an exemplary arrangement of, and relationship between a file system, the partitions, and the underlying physical storage drives. At the lowest level exist the physical storage drives 37 having physical storage media. Physical storage drives 37 may comprise one or more distinct hard disks, magnetic tape drives, removable storage media, optical storage devices, FLASH memory devices, or the like.

Controller 6 maps one or more partitions 38 onto the physical storage media, as described above, and presents the partitions to an operating system executing on processor 4 for use in accordance with a conventional file system 39. In other words, the operating system may utilize the partitions in a manner consistent with usage of conventional partitions across physical storage drives. Controller 6 may present partitions 38 to the operating system via conventional means, but provides hardware-level security to ensure that a malicious user, a virus, or other unforeseen event, does not corrupt partition table 11 or any “offline” partitions currently marked as secure. In other words, upon receiving access requests from processor 4 to read partition information from storage drives 37, controller 6 may intercept the commands and provide information from partition table 11.

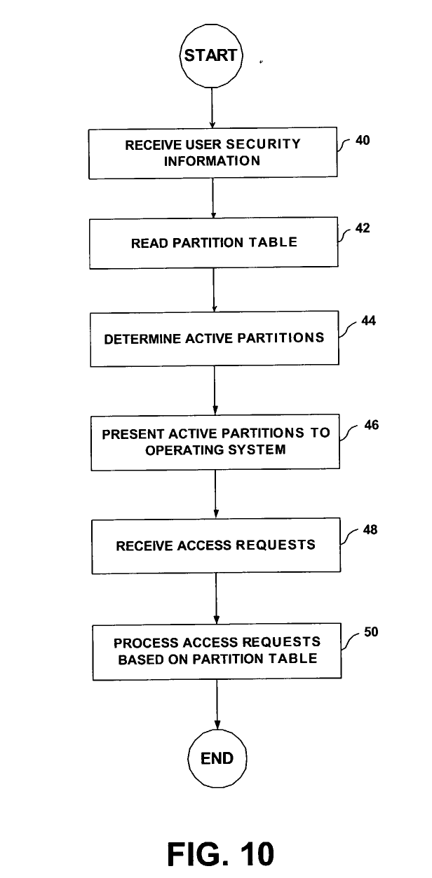

FIG. 10 is a flowchart illustrating a high-level overview of the hardware-level security and management features provided by controller 6 on a partition-by-partition basis. Initially, controller 6 may receive user-specific security information, such as a user identifier, password, digital signature or other credential, or the like (40). Processor 4 (FIG. 1) may, for example, capture the information from a current user during the initial boot stages. Alternatively, the operating system executing on processor 4 may capture the information each time a new user logs into host computing device 2. Processor 4 relays the information to controller 6.

Based on the user information, controller 6 reads partition table 11 from a set of stored partition tables (42). In particular, controller 6 may maintain a plurality of partition tables, each for different users. In this manner, certain partitions may be active for some users, but secure, i.e., inaccessible to others. Alternatively, controller 6 may maintain a single partition table 11 that stores profiles of different users, and sets the status of each partition based on the stored user profiles. Upon reading a respective partition table 11 for the user, controller 6 analyzes the partition table 11 to determine the active partitions (44). Controller 6 presents the active partitions to the operating system for use with a conventional file system (46).

In this fashion, controller 6 may selectively present individual partitions or groups of the partitions to processor 4 depending on a current configuration of host computing device 2. For example, for any current configuration, any number of the partitions may be “offline” and inaccessible to processor 4, while other the partitions may be “online.” The controller selects a subset of the partitions as active partitions, and communicates to the operating system a portion of the partition data that defines the active partitions.

In addition, controller 6 supports the dynamic addition or removal of partitions after booting. For example, controller 6 may designate a partition as a removable device that can be “hot swapped,” i.e., plugged or unplugged during operation of processor 4. The user may initiate a hot swapping of a partition by interacting with the operating system, as with conventional removable devices. In response, controller 6 may designate the partition as accessible or inaccessible, depending upon the request.

As an example, consider the situation where the interface protocol between processor 4 and controller 6 limits the number of “on-line” physical drives to two. In this environment, a user may define an arbitrary number of partitions, of which only two can be online at a give time. Accordingly, the user may define a single boot partition, and may configure the other partitions as removable drives. In this configuration, the user may selectively “swap” the partitions to access different physical drives. Controller 6 maintains the partitions as if they were physically separate, thereby preventing corruption of any offline drives via software executing on processor 4. The user may, for example, configure one or more swappable drives for use by family members. The user may configure other drives to store work, financial, legal or other important files. Accordingly, controller 6 provides hardware level security to prevent a virus from corrupting any of the data of an offline partition, even though the partitions may be allocated to the same physical storage device. Furthermore, as described in detail below, each partition may be individually configured for substantially instant save and restore.

Upon presenting the active partitions to the operating system, controller 6 receives storage access requests from processor 4 (48). Controller 6 processes the storage access requests based on the current partition table 11 (50). For example, controller 6 may reject write access requests to partitions designated as read-only, and may reject all access requests to partitions other that are not identified as active partitions. Furthermore, controller 6 may reject and access commands that may corrupt partition table 11 itself. Otherwise, the operating system executing on processor 4 may access the file system layered on top of the partitions in a conventional fashion. In particular, controller 6 need not translate storage addresses or perform other address processing that may consume resources and increase access time.

In addition, controller 6 may provide hardware-level security to file system objects, e.g., on a directory-by-directory basis, or even a file-by-file basis. For example, controller 6 may receive ranges of logical block addresses from a driver of operating system executing on processor 4, and may selectively filter intercepted data access commands based on the specified ranges. For example, controller 6 may prevent access, or provide read-only access, to ranges of logical block addresses within a given partition. As another example, controller 6 may read file system information for each partition defined in the partition table, and may provide hardware-level control to the files or directories based on parameters set within the file system.

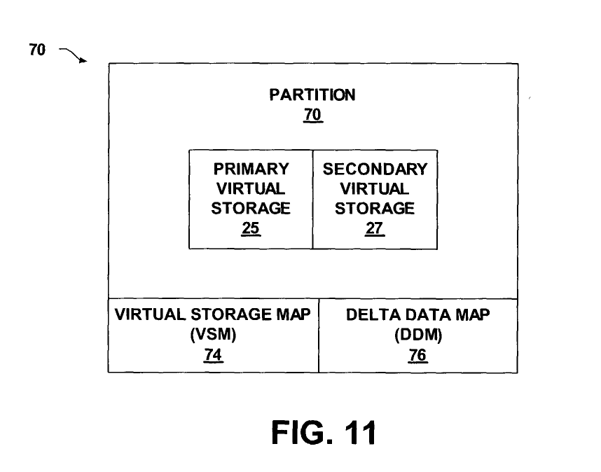

FIG. 11 is a block diagram illustrating in further detail an example partition configured for backup and restoration. In particular, partition 70 is configured to include dynamic virtual storage to save and restore data within a computing environment. Partition 70 includes virtual storage 72 that is used to maintain primary virtual storage 25 and secondary virtual storage 27 for the respective partition 70.

As described in detail herein, controller 6 uses primary virtual storage 25 to store an initial state of data written processor 4 prior to a point in time, referred to herein as time T₀. In other words, primary virtual storage 25 stores a complete image of the data at time T₀. Controller 6 uses secondary virtual storage 27 to store all data written by processor 4 subsequent to time T₀. Consequently, controller 10 responds to read requests received from processor 4 by selectively reading data from secondary virtual storage 27 and primary virtual storage 25, depending on whether data stored by primary virtual storage 25 has been rendered obsolete by data stored by secondary virtual storage 27.

Controller 6 provides the ability to quickly create a new complete image of the data by dynamically reallocating primary virtual storage 25 and secondary virtual storage 27. In particular, controller 6 maintains a virtual storage map (VSM) 74 that defines the allocation of the primary and secondary virtual storage within partition 70.

VSM 74 defines a set of logical storage units within each of primary virtual storage 25 and secondary virtual storage 27. The units may correspond to ranges of addresses, data blocks, sectors, or other units of storage within virtual storage 72 of partition 70. In one embodiment, VSM 74 comprises a bitmap containing a set of binary values. Each binary value corresponds to a respective storage unit. A binary value of 1, for example, may indicate that the corresponding storage unit is allocated to primary virtual storage 25. A binary value of 0, however, may indicate that the storage unit is allocated to secondary virtual storage 27. Controller 6 may easily reallocate a storage unit from one virtual storage to another by changing a state of the corresponding binary value of VSM 74.

By adjusting VSM 74, controller 6 can quickly reallocate primary virtual storage 25 to include the data written to secondary virtual storage 27, thereby establishing a new time T₀ for primary virtual storage 25. Consequently, controller 6 can quickly backup data by dynamically reallocating virtual storage, such as by adjusting VSM 74. In this manner, the system can backup data in a manner that appears almost instantaneous to the user. The user, therefore, need not refrain from using the computing device for a significant period of time, as is often required by conventional backup mechanisms.

Partition 70 further includes a delta data map (DDM) 76 to record the locations of data written to secondary virtual storage 27. In one embodiment, DDM 76 comprises a bitmap having a set of binary values. Each binary value of the set corresponds to a logical storage unit within secondary virtual storage 27, and indicates whether data has been written to secondary virtual storage 27 subsequent to a time T₀. In this manner, controller 6 can readily determine whether to read data from secondary virtual storage 27 or from primary virtual storage 25 based on the DDM.

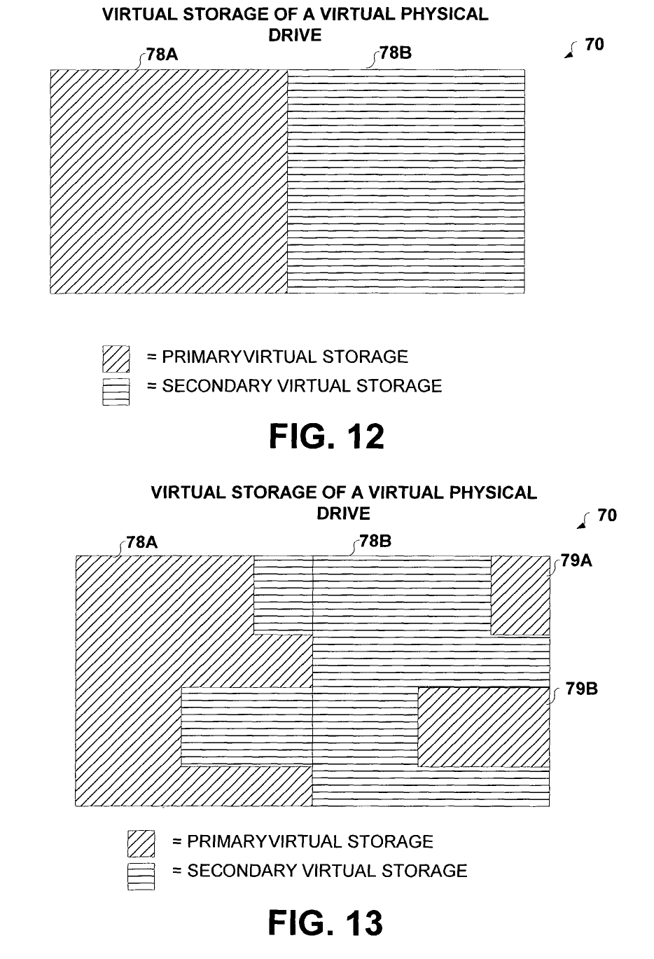

FIG. 12 illustrates an example mapping of primary virtual storage 25 and secondary virtual storage 27 to partition 70 at a time T₀. In particular, FIG. 12 illustrates the initial allocation of primary virtual storage 25 and secondary virtual storage within the partition 70. In this example, VSM allocates two storage regions 78A, 78B within virtual storage 72. Initially, primary virtual storage 25 is entirely allocated to storage region 78A. Similarly, secondary virtual storage 27 is entirely allocated to storage region 78B.

FIG. 13 illustrates the same storage regions 78 at time a new time T₀ after controller 6 has performed a save operation, thereby dynamically reallocating primary and secondary virtual storage of the partition 70 and establishing a new To state. In particular, primary virtual storage 25 comprises a substantial portion of storage region 78A, but has been reallocated to include portions of storage region 78B.

Specifically, regions 79A and 79B of storage region 78B have been dynamically reallocated to primary virtual storage 25. Similarly, the corresponding regions within storage region 78A have been allocated to secondary virtual storage 27. As illustrated, primary virtual storage 25 and secondary virtual storage 27 may be distributed throughout the partition as a result of allocation and reallocation due to save commands. As described in further detail below, by reallocating the primary and secondary virtual storage within the partition, controller 6 is able to quickly perform a save operation in a manner that appears instantaneous to the user.

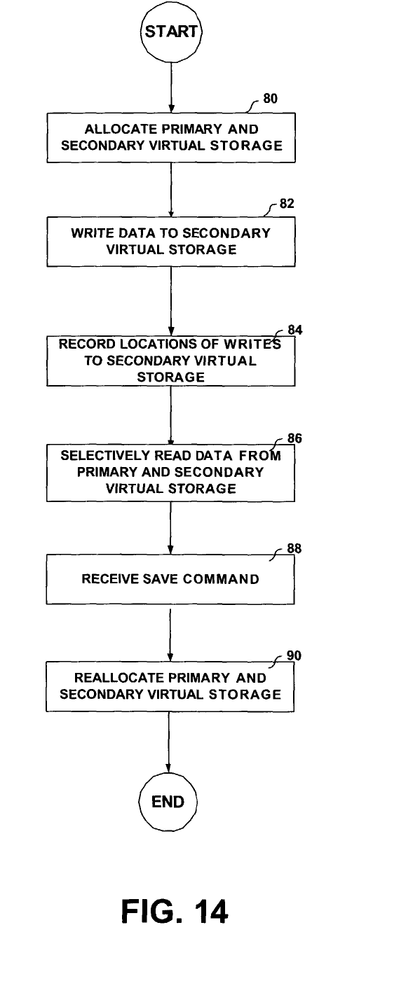

FIG. 14 is a flowchart illustrating a high-level overview of the functions performed by controller 6 to backup a partition in a manner that appears substantially instant to a user. Initially, controller 6 allocates primary virtual storage 25 and secondary virtual storage 27 within storage system 8 (80). In this manner, controller 6 defines an initial state at a time T₀ for primary virtual storage 25 and secondary virtual storage 27. After allocating virtual storage 25, 27 for the partition, controller 6 writes all data received from processor 4 to secondary virtual storage 27 (82).

Controller 6 maintains a record, e.g., DDM 76, of the locations to which data has been written to secondary virtual storage 27 subsequent to time T₀ (84). Controller 6 makes use of this record in order to respond to read requests received from processor 4. Specifically, upon receiving a read request, controller 6 selectively reads data from primary virtual storage 25 and secondary virtual storage 27 based upon the record (86). For example, if the record indicates that the requested data has been written subsequent to time T₀, controller 6 reads the data from secondary virtual storage 27 and forwards the data to processor 4. Otherwise, controller 6 reads the data from primary virtual storage 25 and forwards the data to processor 4.

Upon receiving a save command (88), controller 6 reallocates primary virtual storage 25 and secondary virtual storage 27 (90). In particular, controller 6 reallocates the virtual storage space such that data written to secondary virtual storage 27 subsequent to the time T₀ is allocated to primary virtual storage 25 and excluded from secondary virtual storage 27. In addition, controller 6 clears the record of data written to secondary virtual storage 27, i.e., clears DDM 76. In this manner, controller 6 establishes a new time T₀ in response to the save command.

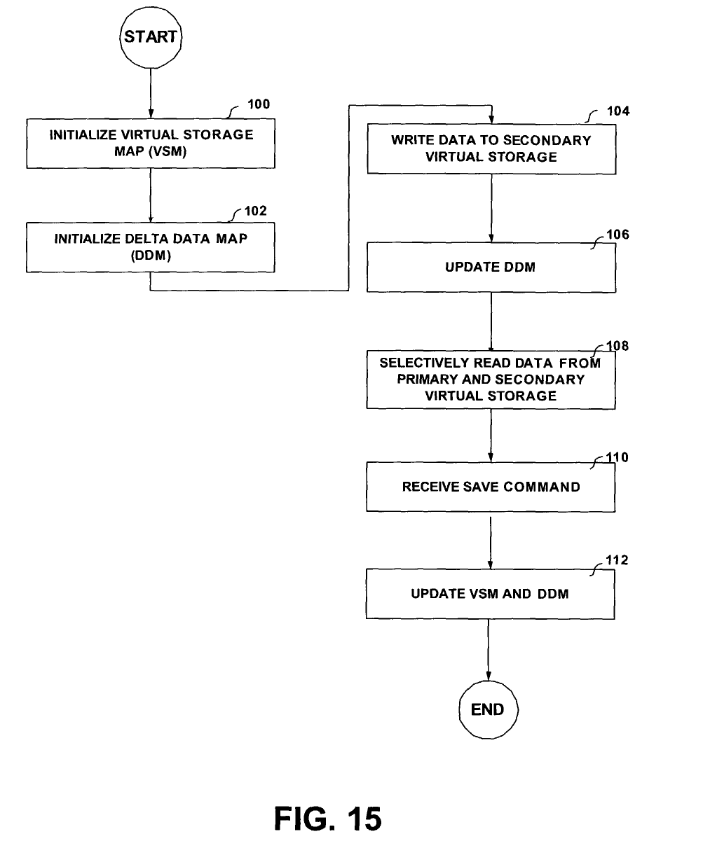

FIG. 15 is a flowchart further illustrating the dynamic allocation of virtual storage 25, 27 of a partition. Initially, controller 6 initializes virtual storage map (VSM) 74 to allocate primary virtual storage 25 and secondary virtual storage 27 (100). Controller 6 may, for example, initialize all of the binary values of VSM 74 to a null value, thereby allocating all storage units of primary virtual storage 25 to a first logical storage volume and all of the storage units of secondary virtual storage 27 to a second logical storage volume. FIG. 12, as described above, illustrates an example initial allocation of primary virtual storage 25 and secondary virtual storage 27.

Next, controller 6 initializes the delta data map (DDM) 76 by setting all of the binary values to a null value (102). In this manner, controller 6 resets DDM 76 to indicate that no data has yet been stored to secondary virtual storage 27 subsequent to the allocation. Next, controller 6 writes data to secondary virtual storage 27 in response to write requests received from processor 4 (104). After writing the data, controller 6 updates DDM 76 to record the locations of the data written to secondary virtual storage 27 (106). In particular, controller 6 may change the state of the corresponding binary values within DDM 76 from a null value to a logical one, thereby marking the storage units as containing data written subsequent to time T₀.

Upon receiving a read request from processor 4, controller 6 selectively reads data from primary virtual storage 25 and secondary virtual storage 27 based upon the state of the binary data within DDM 76 (108). More specifically, controller 6 reads the appropriate binary values of DDM 76 to determine whether the data requested by processor 4 has been written to secondary virtual storage 27. If so, controller 6 reads the data from secondary virtual storage 27 and forwards the data to processor 4. If, however, the data has not been written from processor 4 subsequent to a time T₀, controller 6 reads the data from primary virtual storage 25 and forwards the data to processor 4.

Upon receiving a save command (110), controller 6 reallocates primary virtual storage 25 and secondary virtual storage 27 by updating VSM 74 and DDM 76 (112). In general, controller 6 examines DDM 76 to identify those storage units within secondary virtual storage 27 that contain data written by processor 4 subsequent to time T₀. Controller 6 then updates VSM 74 to reallocate primary virtual storage 25 to include the identified storage units of secondary virtual storage 27 (112). In this manner, the storage units of secondary virtual storage 27 that contain data written subsequent to time T₀ are redefined to be included within primary virtual storage 25. Consequently, the corresponding storage units within primary virtual storage 25 that contain old data are automatically redefined to be included within secondary virtual storage 27. Controller 6 resets DDM 76 by setting all of the binary values to null. In this manner, controller 6 marks all of the storage units within secondary virtual storage 27 as being initialized and available to store new data. In this manner, controller 6 establishes a new time T₀ for the partition.

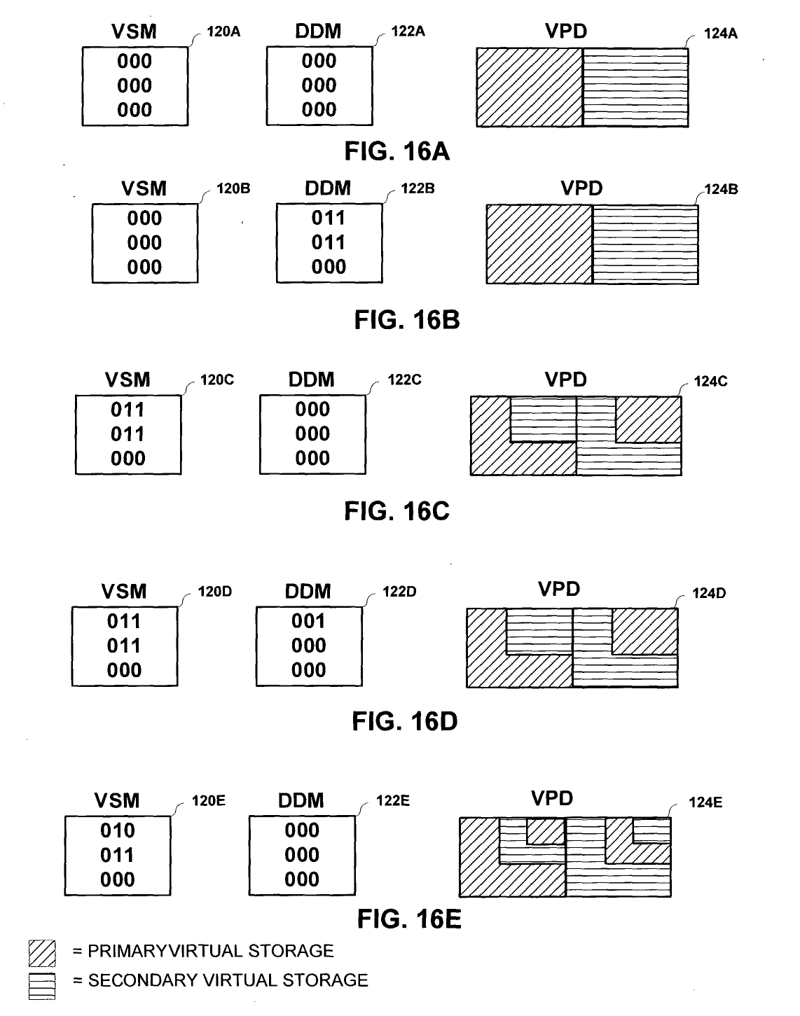

FIGS. 16A-16E illustrate in further detail the process of dynamically reallocating virtual storage of a partition to save data in a manner that appears instantaneous to a user. FIG. 16A illustrates an initial state in which VSM 120A is reset such that primary virtual storage 25 is mapped entirely to a first storage region of the virtual storage, and secondary virtual storage 27 is mapped entirely to a second storage region of the partition (partition). In addition, DDM 122A is initialized to indicate that secondary virtual storage 14 of partition 124 currently contains no data written subsequent to a time T₀.

FIG. 16B illustrates the changes to DDM 122 after a number of write requests from processor 4. In particular, DDM 122B indicates that 4 storage units of secondary virtual storage 27 contain data that has been written subsequent to initial state of time T₀.

FIG. 16C illustrates the changes to VSM 120C and DDM 122C made by controller 6 in response to receiving a save command from a user, such as a system administrator. In particular, controller 6 identifies the storage units of DDM 122B that store data written subsequent to time T₀. Controller 6 then modifies VSM 120C to reallocate primary virtual storage 25 and secondary virtual storage 27. In particular, controller 6 modifies the corresponding binary elements of VSM 120C such that primary virtual storage 25 includes those storage units of secondary virtual storage 27 to which data has been written subsequent to time T₀. Controller 6 may quickly and efficiently effect this dynamic reallocation by performing an exclusive-or (XOR) operation between DDM 122C VSM 120C.

FIG. 16D illustrates the changes made to DDM 122D upon receiving an additional write request from processor 4. In particular, controller 6 writes the data to secondary virtual storage 27 and update DDM 122D.

FIG. 16E illustrates the changes made by controller 6 in response to a second save command. In particular, controller 6 updates VSM 120E to reallocate primary virtual storage 25 and secondary virtual storage 27, and clears DDM 122E.

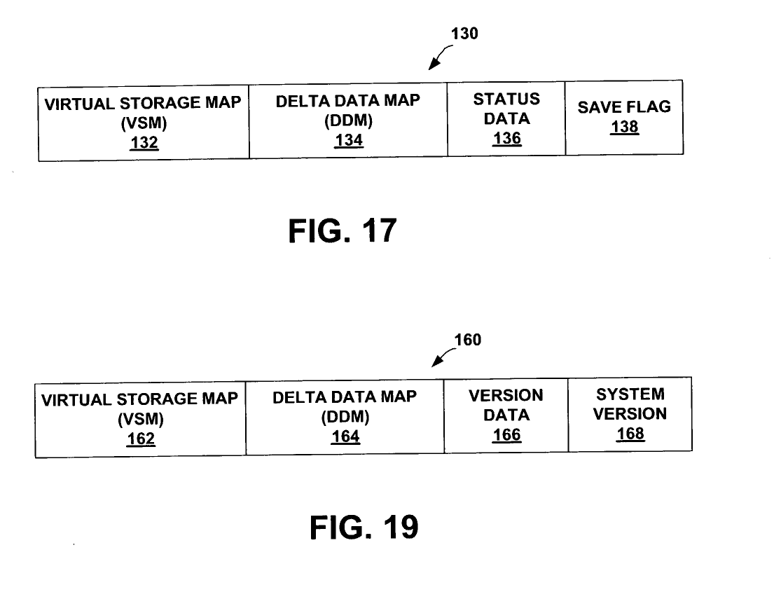

FIG. 17 is block diagram illustrating another example data structure 130 maintained by controller 6 for dynamically allocating and reallocating virtual storage. In this embodiment, data structure 130 includes VSM 132, DDM 134 and additional status data 136. In particular, status data 136 indicates whether each storage unit of secondary virtual storage 27 needs to be reallocated after a save command. Save flag 138 represents a whether a save is pending and must be performed.

Status data 136 may comprise a bitmap having a set of binary values. Each binary value may correspond to a storage unit within secondary virtual storage 27. The state of the binary value represents whether the corresponding storage unit has been reallocated, if necessary, in response to a recent save command. In this manner, data structure 130 may be useful when controller 6 performs the reallocation in the background, such as during free cycles of a system bus within a host computing device. Thus, by including status data in the data structure, the reallocation can be performed solely during free cycles. If the free cycles are interrupted, status data 136 can maintain an indication of the status of the reallocation so that it can be finished during subsequent free cycles. In this manner, controller 6 can perform reallocation without using non-free cycles.

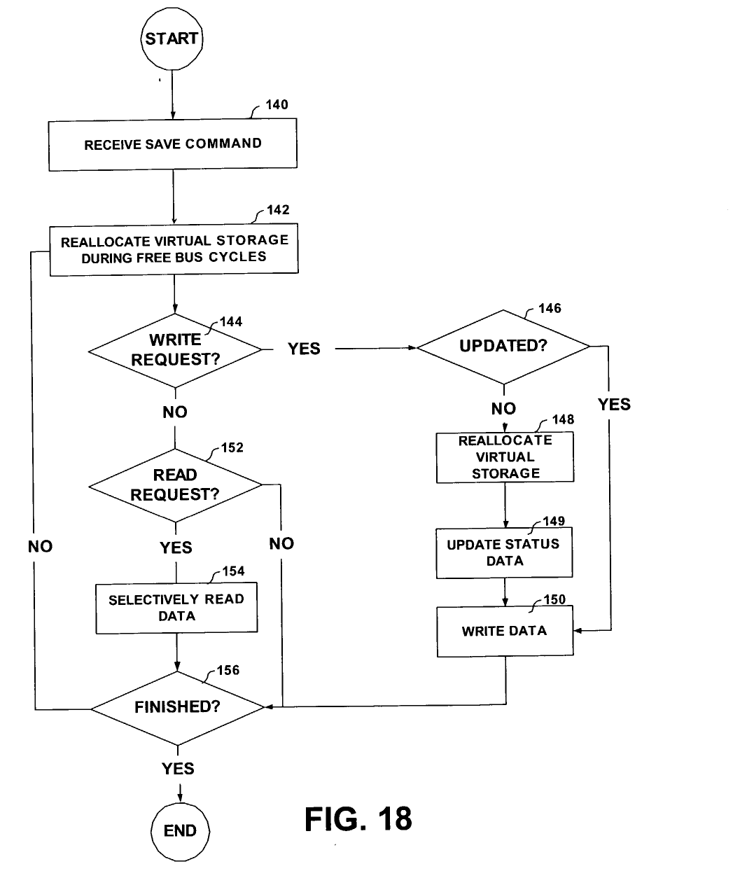

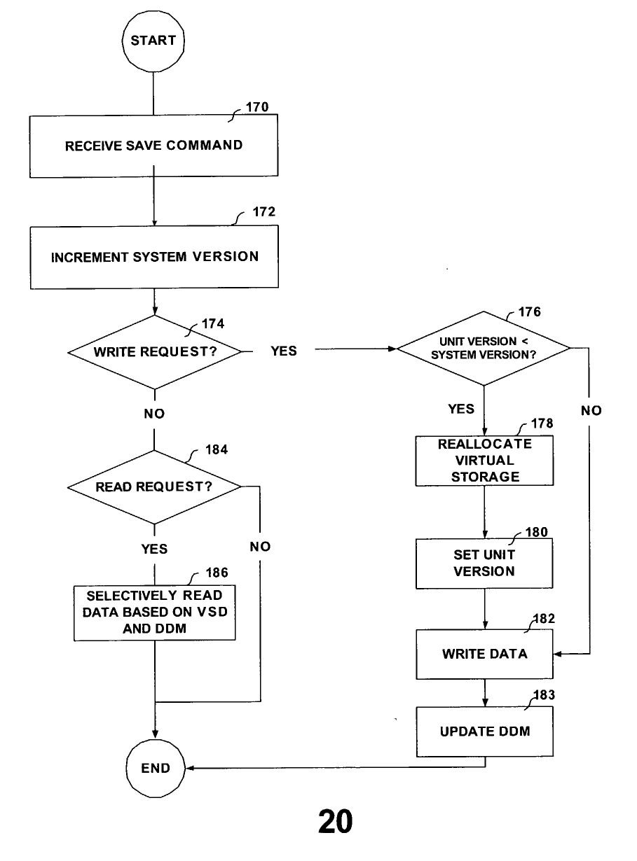

FIG. 18 is a flowchart illustrating the reallocation of virtual storage by controller 6 when making use of data structure 130. Upon receiving a save command (140), controller 6 sets a global flag 138 indicating that a save must be performed and begins updating VSM 132 and DDM 134 during the background, i.e., between servicing of access requests received from processor 4 (142). Upon reallocating a storage unit, controller 6 sets the value of a corresponding bit within status data 136 to indicate that reallocation has either been performed or is not needed.

During this process, if controller 6 receives an allowable write request, i.e., a write request to a partition or a region of a partition for which write commands are currently allowed in view of the partition data(144), controller 6 accesses status data 136 to determine whether the storage units holding the requested data have been updated in response to the previous save command (146). If so, controller 6 immediately writes the data to the storage units of secondary virtual storage 27 (150). If not, controller 6 updates VSM 132 and DDM 134 (148) and status data 136 (149) prior to writing the data (150).

If an allowable read request is received, i.e., a read request to a partition or a region of a partition for which read commands are currently allowed in view of the partition data (152), controller 6 selectively reads data from primary virtual storage 25 and secondary virtual storage 27 in accordance with DDM 134 as described above (154). Controller 6 continues to update status data 136 in the background until all of the storage units containing data written subsequent to time T₀ have been reallocated from secondary virtual storage 27 to primary virtual storage 25 (156).

FIG. 19 is a block diagram illustrating another embodiment of a data structure 160 maintained by controller 6 for dynamically allocating and reallocating virtual storage. In this embodiment, data structure 160 includes VSM 162, DDM 164, version data 166 and a system version 168. In particular, version data 166 stores a version number for each storage unit of secondary virtual storage 27. More specifically, the version number corresponds to a save command received by controller 6, and indicates whether the storage unit is up to date. System version 168 stores the most recent version for all of secondary virtual storage 27, and is based upon the save commands received from I/O device 26. In particular, each time controller 6 receives a save command, controller 6 increments system version 168.

FIG. 20 is a flowchart illustrating the operation of controller 6 when using data structure 160 of FIG. 18. Upon receiving a save command (170), controller 6 increments the system version 168 (172). Upon receiving a write request (174) controller 6 compares the version for the requested storage unit, as indicated by version data 166, with the system version 168 (176).

If the version number for the requested storage unit is less than system version 168, controller 6 initiates a reallocation of the storage unit from secondary virtual storage 27 to primary virtual storage 25 (178) and sets the version number for the storage unit to system version 168 (180). Next, controller 6 writes the data to the storage unit of secondary virtual storage 27 (182) and updates DDM 164 to indicate that the storage unit contains data subsequent to the last save command (183).

If however, the version number for the storage unit requested is equal to system version 168, controller 6 writes the data to secondary virtual storage 27 (182) without updating VSM 162 to reallocate storage units (182) and updates DDM 164 (183). If controller 6 receives a read request, controller 6 accesses DDM 164 and selectively reads data from secondary virtual storage 27 and primary virtual storage 25 (186).

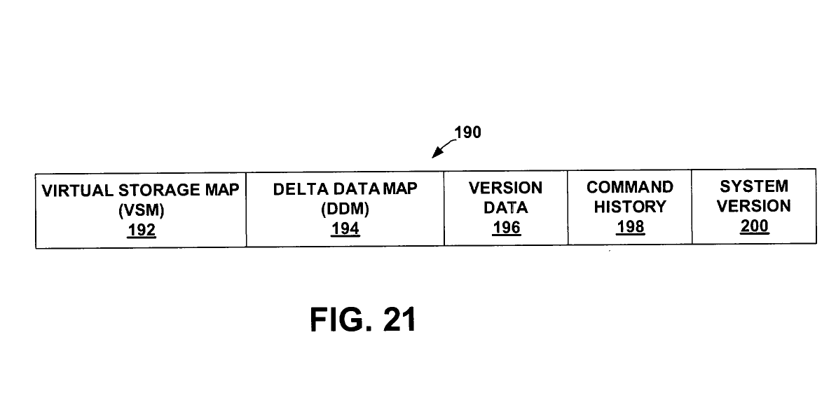

FIG. 21 is a block diagram illustrates another embodiment of a data structure 190 maintained by controller 6 for dynamically allocating and reallocating virtual storage of a partition. In this embodiment, data structure 190 includes VSM 192, DDM 194, version data 196, command history 198 and a system version 200. In particular, command history 198 comprises a log indicating the sequence of save and restore commands received be controller 6. Command history 198 may comprise, for example, a bitmap in which a binary value of one represents a save command and a binary value of zero represents a restore command. A sequence of 11101, for example, represents the following sequence: SAVE, SAVE, SAVE, RESTORE, SAVE.

In this embodiment, version data 196 may store an index into command history 198. In this manner, the version number indicates the last command, save or restore, applied to a particular storage unit of secondary virtual storage 27. In other words, by indexing into command history 148, the version number indicates a current state for the respective storage unit.

Upon receiving a read request from processor 4, controller 6 accesses version data 196 to determine if the version for the accessed storage unit is less than system version 200. If so, controller 6 reallocates VSM 192 and updates the version data 196 for the accessed storage unit. In this manner, controller 6 may update data structure 190 within local memory 22. For write requests, controller 6 may perform a similar operation and save data structure 190 to storage system 8.

Upon receiving a save or restore command, controller 6 may update command history 198 to reflect the command, save data structure 190 to storage system 8, and increment system version 200. This allows controller 6 to perform a save or restore for a partition in a manner that appears instantaneous to the user.

The features described herein may be implemented in a wide variety of computing environments. Consider, for example, a laptop computer incorporating the features described herein. A common problem with conventional laptops is that corruption of the hard drive may render the device unusable for a substantial period while the user completes his or her travel. In other words, the laptop typically is unusable until the user returns such that an IT staff member can service the laptop.

By incorporating the features described herein, the laptop may be configured with one or more partitions that are readily protected by hardware from viruses or other malicious software. Furthermore, in the event of such a recurrence, one or more of the partitions may be restored to an operating state prior to the corruption.

For example, controller 6 may be incorporated within the laptop, and may map a first and second partition to the storage space presented by the hard drive. The first partition may be configured as a boot partition and may store application software, such as word processing and other software executables. This partition may be further configured to support dynamic virtual storage for purposes of backup and restore. The second partition may be used to store the data files used by the application. Accordingly, in the event of corruption, the first partition may be instantly restored to operation by reallocating the primary and secondary virtual storage. Virus protection software may then be run on the second drive, thereby allowing the user to quickly retrieve data files without losing significant work product, including work product generated during the trip subsequent to the last backup of the first partition. Alternatively, both the first and second partitions may be configured for backup and restoration.

As another example, the features may readily be incorporated into a server, such as a file server for an office environment. As with the laptop environment, controller 6 may map a first and second partition to the storage space presented by the server. The first partition may be configured as a boot drive and may store application software, such as conventional server management software. This partition may be further configured to support dynamic virtual storage for purposes of backup and restore. The second partition may be used to store the data files for the office. In the event of corruption, the first drive may be instantly restored to full operation by reallocating the primary and secondary virtual storage. Virus protection software may then be run on the second drive, thereby allowing the office to quickly retrieve data files without experiencing significant loss of productivity.

By only configuring the first partition for restoration and backup, controller 6 can make use of the vast majority of the storage space of the server for use as primary virtual storage. For example, the first partition that stores that application software may be allocated to consume 1 gigabyte or less of storage space, while the second partition may be allocated to consume the remainder, which may easily comprise 100 gigabytes or more of space. The configuration of the first partition for instant backup and restore results in only 2 gigabytes of total space, i.e., 1 gigabyte for each of the primary and secondary virtual storage. This inefficiency is avoided for the second partition, allowing nearly all of the storage space of the server to be used for primary virtual storage. Alternatively, if the user elects, both the first and second partition of the server may be configured for backup and restoration, thereby allowing for the immediate restoration of both partitions.

The training environment is another example of an environment that may readily benefit from the features described herein. In such an environment, a partition may easily be created for each user of a class. A user can instantly restore each partition to a know operating state after the training session by simply pressing the restore button, resulting in the dynamic reallocation of primary and secondary virtual storage for each of the partitions.

Various embodiments of the invention have been described. These and other embodiments are within the scope of the following claims.

1. A computing system comprising:
a processor having an operating system executing thereon;
a storage system having one or more storage media; and
a controller coupled between the processor and the storage system, wherein the controller maintains partition data defining one or more partitions for the storage media in response to commands received from the operating system, and controls access to the storage media by the processor in accordance with the partition data.

2. The computing system of claim 1, wherein the controller designates at least one of the partitions as read-only, and rejects write requests from the processor addressed to the read-only partition.

3. The computing system of claim 1, wherein the controller selects a subset of the partitions as active partitions, and communicates to the operating system a portion of the partition data that defines the active partitions.

4. The computing system of claim 3, wherein the controller intercepts storage access requests from the processor, and rejects storage accesses requests that are not directed to the active partitions.

5. The computing system of claim 3, wherein the operating system supports up to M partitions, and the controller maintains the partition data to define N partitions for the storage devices, where N≧M.

6. The computing system of claim 5, wherein M=4.

7. The computing system of claim 5, wherein the controller selects the subset to include M partitions.

8. The computing system of claim 3, wherein the controller receives a user identifier from the operating system, and selects the subset of the partitions based on the user identifier.

9. The computing system of claim 3, wherein the controller maintains the partition data to store user identifiers and security information for authorized users.

10. The computing system of claim 6, wherein the controller receives security information and identification during a logon session of a user, authenticates the received security information and identification with the user identifiers and security information of the partition data, and selects the subset of the partitions based on the authentication.

11 The computing system of claim 3, wherein the operating system formats the subset to create a file system.

12. The computing system of claim 1, wherein the processor receives security information identifying an authorized user, and the controller provides access to a subset of the partitions based on the security information.

13. The computing system of claim 1, wherein the controller maintains the partition data as a plurality of partition tables.

14. The computing system of claim 1, wherein the controller maintains the partition data as a single partition table.

15. The computing system of claim 1, wherein the partition data includes a set of partition entries that define the partitions, and each partition entry associates an authorized user with each of the respective partitions.

16. The computing system of claim 15, wherein each partition entry includes security information for each of the users for authentication by the controller.

17. The computing system of claim 1, wherein the partition data designates at least one of the partitions as enabled for data backup and restoration.

18. The computing system of claim 17, wherein the controller stores a virtual storage map (VSM) to allocate a primary virtual storage and a secondary virtual storage within the designated partitions, and further wherein the controller maintains a record of the data written to the secondary virtual storage, and selectively reads data from the primary virtual storage and the secondary virtual storage based on the record.

19. The computing system of claim 18, wherein the controller stores data received from the processor prior to a time T₀ on the primary virtual storage of the designated partitions, and stores data received from the processor after time T₀ on the secondary virtual storage of the designated partitions.

20. The computing system of claim 18, further comprising an input/output (I/O) interface to receive a save command, wherein the controller reallocates the primary virtual storage of at least one of the designated partitions in response to the save command.

21. The computing system of claim 20, wherein the I/O interface receives a signal from one of an actuated switch and a wireless signal.

22. The computing system of claim 20, wherein the I/O interface receives the save command from software executing on a computing device.

23. A method comprising:
maintaining, with a controller partition, data that defines one or more partitions for a storage medium in response to commands received from a processor executing on a processor coupled to the controller;
processing the partition data with the controller to select a subset of the partitions as active partitions; and
identifying the active partitions to the processor.

24. The method of claim 23, further comprising:
intercepting storage access requests from the processor with the controller; and
rejecting any of the storage access requests addresses that are not directed to the active partitions.

25. The method of claim 24, further comprising maintaining the partition table to define N partitions for the storage devices, where an operating system executing on the processor supports up to M partitions, and N≧M.

26. The method of claim 25, further comprising processing the partition data to select up to 4 active partitions.

27. The method of claim 23, further comprising:
receiving a user identifier from the processor, and
selecting the subset of the partitions based on the user identifier.

28. The method of claim 23, further comprising:
maintaining the partition data to store user identifiers and security information for authorized users;
receiving security information and identification during a logon session of a user;
authenticating the received security information and identification with the user identifiers and security information of the partition data, and
selecting the subset of the partitions based on the authentication.

29. The method of claim 23, further comprising maintaining the partition data as a plurality of partition tables.

30. The method of claim 23, further comprising maintaining the partition data as a single partition table.

31. The method of claim 23, wherein identifying the active partitions comprises communicating a portion of the partition data that defines the active partitions to a processor coupled to the controller.

32. The method of claim 23, wherein the partition data designates at least one of partitions as read-only, the method further comprising rejecting write requests from the processor addressed to the read-only partitions.

33. The method of claim 23, further comprising maintaining the partition data to designate at least one of the partitions as enabled for data backup and restoration.

34. The method of claim 33, further comprising:
storing data received from the processor prior to a time T₀ on a primary virtual storage within the designated partition; and
storing data received from the processor after time T₀ on a secondary virtual storage within the designated partition.

35. The method of claim 33, further comprising:
receiving a save command at a time T₀; and
establishing a T₀ state in response to the save command in which data received from the processor prior to the time T₀ is stored on the primary virtual storage and data received from the host computer after time T₀ is stored on the secondary virtual storage.

36. The method of claim 33, further comprising:
receiving a restore command subsequent to a time T₀; and
disregarding the data received from the processor after the time T₀ in response to the restore command.

37. The method of claim 33, further comprising:
generating a virtual storage map (VSM) to allocate the primary virtual storage and the secondary virtual storage within the designated partition;
maintaining a record of the data written to the secondary virtual storage; and
selectively reading data from the primary virtual storage and the secondary virtual storage based on the record.

38. The method of claim 23, further comprising reporting at least one of the partitions to the processor as read-only.

39. The method of claim 37, wherein maintaining a record comprises:
defining a delta data map (DDM) having a status bit for corresponding storage units for the primary and secondary virtual storage; and
setting the status bits of the delta data map to indicate whether data has been written to the storage units of the secondary virtual storage.

40. An apparatus comprising:
a computer-readable medium to store partition data that defines partitions for one or more storage media of a storage system;
a control unit to maintain the partition data in response to commands from an operating system executing on a processor of a host computer;
a first interface to couple the control unit to the processor via a bus; and
wherein the control unit controls access to the storage media of the storage system in accordance with the partition data.

41. The apparatus of claim 40, further comprising a second interface coupling the control unit to the storage system.

42. The apparatus of claim 40, wherein the first interface couples the control unit to the storage system.

43. The apparatus of claim 40, wherein the control unit selects a subset of the partitions as active partitions, and communicates to the processor a portion of the partition data that defines the active partitions.

44. The apparatus of claim 40, wherein the control unit reports at least one of the partitions as a swappable drive to an operating system executing on the processor, and updates the active partitions to include the swappable partition in response to input from the user.

45. The apparatus of claim 43, wherein the controller intercepts storage access requests from the processor, and rejects storage accesses requests that are not directed to the active partitions.

46. The apparatus of claim 43, wherein an operating system executing on the processor supports up to M partitions, and the control unit maintains the partition data to define N partitions for the storage devices, where N≧M.

47. The apparatus of claim 46, wherein M=4.

48. The apparatus of claim 40, wherein the controller stores a virtual storage map (VSM) on the computer-readable medium to allocate a primary virtual storage and a secondary virtual storage within one or more of the partitions, and further wherein the controller maintains a record of the data written to the secondary virtual storage of the partitions, and selectively reads data from the primary virtual storage and the secondary virtual storage based on the record.

49. The apparatus of claim 48, wherein the controller stores data received from the processor prior to a time T₀ on a primary virtual storage of the partitions, and stores data received from the processor after time T₀ on a secondary virtual storage of the partitions.

50. A computer-readable medium comprising partition data that defines partitions for a storage medium for use by a hardware controller situated between a storage medium and a host processor to provide secure access to the partitions, wherein the partition data associates an authorized user with each of the partitions.

51. The computer-readable medium of claim 50, wherein the partition data further comprises security information for each of the users for use by the controller to authenticate the users on a partition-by-partition basis.

52. The computer-readable medium of claim 50, wherein the partition data further comprises security information that identifies an authorized user, and the controller provides access to a subset of the partitions based on the security information.

53. The computer-readable medium of claim 50, wherein the partition data comprises a plurality of partition tables.

54. The computer-readable medium of claim 50, wherein the partition data comprises a single partition table.

55. The computer-readable medium of claim 50, wherein the partition data defines N partitions, and wherein an operating accessing the computer-readable medium supports up to M partitions, where N≧M.

56. The computer-readable medium of claim 55, wherein N≧4.

57. The computer-readable medium of claim 50, wherein the partition data defines two or more subsets of the partitions for mutually exclusive access by the controller.

58. A computing system comprising:
a processor having an operating system executing thereon;
a storage system having one or more storage media; and
a controller coupled between the processor and the storage system, wherein the controller maintains partition data defining one or more partitions for the storage media in response to commands received from the operating system, and controls access to file system objects stored within the partitions.

59. The computing system of claim 58, within the controller receives ranges of logical block addresses (LBAs) within the partitions from the processor, intercepts data access commands from the processor, and selectively rejects the data access commands in accordance with the received ranges.

60. The computing system of claim 58, the controller receives retrieves file system information for the partitions, intercepts data access commands from the processor, and selectively rejects the data access commands on an file system object-by-object basis in accordance with the file system information.
